(19) United States
(12) Patent Application Publication
(10) Pub. No.: US 2026/0290110 A1
(43) Pub. Date: Sep. 24, 2026

(54) AUTOMATED FOOD DISTRIBUTION APPARATUS

(71) Applicant: Sallapack AB, Uddevalla (SE)

(72) Inventor: Nils OLSSON, Uddevalla (SE)

(21) Appl. No.: 19/474,804

(22) PCT Filed: Apr. 11, 2024
(86) PCT No.: PCT/EP2024/059859

§ 371 Date: Oct. 13, 2025

(30) Foreign Application Priority Data
Apr. 14, 2023 (SE) 2350436-8

(51) Int. Cl. G07F 11/52

(52) U.S. Cl. CPC G07F 11/52

(57) ABSTRACT

A food dispenser for distributing food onto a food tray, a food dispensing system comprising said food dispenser, and a method for distributing food using said food dispenser. The food dispenser comprises: a first canister provided with an opening in a bottom surface of the first canister; a first rotor arranged adjacent to the bottom surface of the first canister, the first rotor being provided with a plurality of paddles, wherein the plurality of paddles of the first rotor and the bottom surface of the first canister form a plurality of pockets in the first canister; a first motor configured to rotate the first rotor to cause the plurality of paddles of the first rotor to sweep food received in the plurality of pockets in the first canister through the opening of the first canister; and a first distribution head arranged on the first rotor, the first distribution head being configured to deflect food fed into the first canister into the plurality of pockets in the first canister.

### TECHNICAL FIELD

The present disclosure relates generally to food dispensers for automatically dispensing food. The present disclosure also relates to a food dispensing system comprising a food dispenser, and to a method for using a food dispenser.

### BACKGROUND

Filling a food tray with food, such as filling a container for a meal of salad, typically involves manual steps of filling the food tray with individual ingredients. In many cases, it is desired that each ingredient is arranged neatly in the food tray. In the example of the container for a meal of salad, a neat arrangement of each ingredient typically makes product more appealing for the consumer.

The food tray may alternatively be filled with one or more ingredients at a time using an automatic food dispenser. Such food dispenser typically is fed with relatively large batches of food (such as one ingredient), and is configured to distribute the food in smaller batches or with a continuous flow in a controlled manner. This control is particularly important when the food should be distributed neatly on the food tray.

Any apparatus handling food should preferably be easy to clean since there are regulations with strict cleanliness requirements for any apparatus handling food.

One type of automatic food dispenser is a so-called “multi-head weigher” (or “multi-head dispenser”), which comprises a plurality of compartments provided with respective scales. Each compartment is filled with food to different extents by means of the respective scales, and each compartment may be opened up to release the content in the compartment. A controlled amount of food is dispensed from the multihued weigher by opening one or more of the compartments. A drawback of the multi-head weigher is, however, that it is relatively complex with many moving parts, which in turn, makes the food dispenser expensive and hard to clean. In addition, multi-head weighers are typically large in terms of physical volume. These drawbacks makes multi-head weighers practically unavailable for most small and medium sized businesses.

There is a need for improved food dispensers that may operate in an automatic fashion. In particular, there is a need for food dispensers, suitable for small and medium sized businesses, that can distribute food in a controlled fashion, that are cost-effective, and that are easy to clean.

### SUMMARY

It is an object of the present disclosure to provide improved food dispensers for dispensing food. This object is at least in part achieved by a food dispenser for distributing food onto a food tray. The food dispenser comprises: a first canister provided with an opening in a bottom surface of the first canister; a first rotor arranged adjacent to the bottom surface of the first canister, the first rotor being provided with a plurality of paddles, wherein the plurality of paddles of the first rotor and the bottom surface of the first canister form a plurality of pockets in the first canister; a first motor configured to rotate the first rotor to cause the plurality of paddles of the first rotor to sweep food received in the plurality of pockets in the first canister through the opening of the first canister; and a first distribution head arranged on the first rotor, the first distribution head being configured to deflect food fed into the first canister into the plurality of pockets in the first canister.

The disclosed food dispenser is particularly suitable for food comprising discrete pieces up to a few centimeters long each. The food may e.g. chopped vegetables, macaroni, meatballs, chopped pieces of chicken etc. The disclosed food dispenser may in general handle the type of food as a multi-head weigher. However, the disclosed food dispenser comprises significantly less or fewer moving parts. Thus, the disclosed food dispenser is easier to manufacture and easier to clean. Furthermore, the disclosed food dispenser is relatively compact in terms of physical volume. Consequently, the disclosed food dispenser is suitable for small and medium sized businesses that typically cannot use the existing automation solutions that typically are too expensive, large, and hard to clean.

The disclosed food dispenser may automatically dispense food onto the food tray. A flow of food may be fed into the first canister. This flow may be fed into the first canister manually or by means of e.g. a conveyor. The first distribution head enables the food fed into the first canister to be evenly distributed into the plurality of pockets in the first canister over time. The food distributed into the plurality of pockets in the first canister is thereafter expelled from the opening of the first canister by rotating the first rotor. The disclosed food dispenser enables dispensing food onto the food tray from the opening of the first canister in a controlled fashion. Here, distributing in a controlled fashion means that the amount of food received onto the food tray can be controlled to a higher degree when using the disclosed food dispenser compared to if the food was distributed directly onto the food tray.

The food dispensed from the opening of the first canister will typically be dispensed evenly over a time, where the dispense rate is controlled by the rotation speed of the first rotor. By controlling the rotation speed of the first rotor, the dispense rate of the food from the opening of the first canister can be controlled to a higher degree compared to the rate of food being feed into the first canister. As an example, a relatively large batch of food may be fed into the first canister at one occasion. In that case, the food dispenser enables a flow of smaller amounts of food to be distributed onto the food tray in a controlled fashion. A batch of food dispensed fed into the first canister will be dispensed in fractions of that batch, where the number of fractions correspond to the number of pockets in the first plurality of pockets. The amount of food in a fraction is dependent on the amount of food in the batch. Dispensing the batch via the fractions enables the food to be distributed onto the food tray in a controlled fashion.

The food may also be fed into the first canister from an opening of a second canister comprising of the same type of co-functioning parts as the first canister.

According to some aspects, the first motor is configured to receive a signal indicating a weight of food on the food tray. The first motor is configured to rotate the first rotor as a function of the weight. This way, additional control of the distribution rate of food from the opening of the first canister is provided. For example, it may be desired to rotate the first rotor slower as the weight of food received on the food tray approaches a desired value. Furthermore, it may be desired to stop rotating the first rotor when the weight of food received on the food tray reaches the desired value.

According to some aspects, the first canister comprises a shaft pipe arranged in the first canister and arranged extending from the bottom surface of the first canister. The shaft pipe is arranged to provide an opening from an inside of the first canister to an outside of the first canister. The first rotor comprises a rotor shaft configured to be driven by the first motor, where rotor shaft of the first rotor is arranged extending through the shaft pipe of the first canister. The shaft pipe of the first canister enables a mechanical connection between the first rotor and the first motor. The shaft pipe of the first canister also prevents food received in the first canister from leaving the first canister through other paths than the opening of the first canister.

Optionally, according to some aspects, the first canister comprises a shaft pipe arranged in the first canister and arranged extending from the bottom surface of the first canister. The shaft pipe is arranged to provide an opening from an inside of the first canister to an outside of the first canister. The first rotor comprises a rotary cuff arranged to receive a motor shaft driven by the first motor, and crossbar configured to be rotated by the motor shaft.

According to some aspects, the first rotor is releasably attached to the first canister. This way, the first canister and the first rotor are easy to clean. Preferably, the first rotor is releasably attached to the first canister such that the first rotor can be disassembled and assembled to the first canister in a toolless fashion.

According to some aspects, the first distribution head is releasably attached to the first rotor. This way, the first distribution head and the first rotor are easy to clean. Preferably, first distribution head and the first rotor are releasably attached to each other such that the first distribution head can be disassembled and assembled to the first rotor in a toolless fashion.

According to some aspects, the first distribution head has a semi-spherical shape. This provides a way of having the first distribution head evenly distributing food into the plurality of pockets in the first canister over time when food is fed into the first canister. Preferably, the first distribution head is symmetrical around a rotational axis of the first rotor.

According to some aspects, the first canister further comprises a blocking member arranged adjacent to the opening of the first canister to prevent food fed into the first canister from being directly fed through the opening of the first canister. When food is fed into the first canister, any food falling towards the opening is at least partially blocked by the blocking member. This way, the flow rate of food dispensed from the opening of the first canister is more controlled.

According to some aspects, the bottom surface of the first canister is conical and is protruding inwards in the first canister. In particular, the bottom surface of the first canister may be conical with the top extending towards the open face of the first canister. This way, a larger amount of food received on the bottom surface of the first canister will be gathered away from the center of the bottom surface of the first canister. This may be advantageous if a central part of a first rotor covers a part of the center of the bottom surface of the first canister.

According to some aspects, the food dispenser further comprises a second canister provided with an opening in a bottom surface of the second canister, and a second rotor arranged adjacent to the bottom surface of the second canister. The second rotor is provided with a plurality of paddles, wherein the plurality of paddles of the second rotor and the bottom surface of the second canister form a plurality of pockets in the second canister. The second rotor is configured to be rotated such that the plurality of paddles of the second rotor sweep food received in the plurality of pockets in the second canister through the opening of the second canister. The second canister is arranged such that food fed from the opening of the second canister is fed into the first canister. Arranging the first and the second canister like this provides additional control of the food distributed by the food dispenser from the opening relative to food received into the food dispenser via the second canister. The food added to the first canister are fractions of the food added to the second canister. The fractions added to the first canister are in turn divided in to smaller fractions in the first canister. Thereby, the output from the first canister are smaller fractions of fractions of the food added to the second canister. Consequently, the first and the second canisters together enable a finer control of the output from the first canister.

According to some aspects, the first canister has a cylindrical shape extending along a first axis. In that case, the first and the second canisters may be arranged such that the first axis extends through the first distribution head and the opening of the second canister. This is an effective way of arranging the first and the second canisters such that food fed from the opening of the second canister is fed onto the first distribution head, where the distribution head will evenly distribute the food into the plurality of pockets in the first canister over time.

According to some aspects, wherein the second rotor is configured to be rotated by the by the first motor. Furthermore, the first motor may be configured to rotate the first rotor at a first peripheral speed and to rotate the second rotor at a second peripheral speed, wherein the second peripheral speed is slower than the first peripheral speed. The first motor may be mechanically connected to the first and the second rotors by different transmissions and different gearing. According to some additional aspects, the second peripheral speed may be slower than the first peripheral speed on average over a predetermined amount of time.

Alternatively, the food dispenser may further comprise a second motor configured to rotate the second rotor. In that case, the first motor may be configured to rotate the first rotor at a first peripheral speed and the second motor may be configured to rotate the second rotor at a second peripheral speed, wherein the second peripheral speed is slower than the first peripheral speed. Here, the second peripheral speed may be slower than the first peripheral speed on average over the predetermined amount of time

The different peripheral speeds of the first and the second rotors (in absolute terms or on average over the predetermined amount of time) allows the food to be distributed with more control through the food dispenser. As an example, food fed into the second canister is distributed into the first canister in controlled fashion, i.e., the flow rate is controlled. Thereafter, food distributed from the first canister is controlled to a higher degree.

There is also disclosed herein a food dispensing system comprising two or more food dispensers according to the discussions above and a conveyor system. The food dispensing system is associated with the above-discussed advantages. The conveyor system is arranged to convey the food tray between different food dispensers of the two or more food dispensers. The food dispensing system can advantageously fill the food tray with different ingredients in an automatic fashion. Each food dispenser in the food dispensing system may be associated with a respective scale comprised in the food dispensing system, where each scale is adapted to weigh food dispensed on the food tray when the food tray is positioned to receive food dispensed from the associated food dispenser. Each scale may be configured to communicate a signal indicating the weight from that scale to the first motor of the associated food dispenser, and to the second motor if the associated food dispenser comprises a second motor. Consequently, the first motor may be configured to rotate the first rotor in response to the signal from the associated scale. Similarly, the second motor may be configured to rotate the second rotor in response to the signal from the associated scale.

There is also disclosed herein a method for distributing food using a food dispenser according to the discussions above. The method is associated with the above-discussed advantages. The method comprises receiving a food quantity into the first canister, and expelling food distributed in the plurality of pockets in the first canister from the opening of the first canister by rotating the first rotor by the first motor.

According to some further aspects, the method comprises obtaining a weight of food distributed on the food tray, and rotating the first rotor by the first motor as a function.

According to some additional aspects, the method comprises receiving a food quantity into the second canister, wherein the receiving a food quantity into the first canister comprises expelling food distributed in the plurality of pockets in the second canister from the opening of the second canister by rotating the second rotor. According to some further aspects, the first rotor is rotated at the first peripheral speed and the second rotor is rotated at the second peripheral speed.

There is also disclosed herein control units, computer programs, computer readable media, computer program products associated with the above-discussed advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present disclosure will become apparent when studying the appended claims and the following description. The skilled person realizes that different features of the present disclosure may be combined to create embodiments other than those described in the following, without departing from the scope of the present disclosure.

### BRIEF DESCRIPTION OF THE DRAWINGS

With reference to the appended drawings, below follows a more detailed description of embodiments of the present disclosure cited as examples. In the drawings:

FIGS. 1A and 1B show different perspective views of an example food dispenser,

FIG. 1C shows a bottom view of the example food dispenser of FIGS. 1A-1B,

FIGS. 2A and 2B show different perspective views of an example first canister,

FIGS. 3A-3C show different perspective views of an example first rotor comprising a first distribution head,

FIG. 4 shows an example motor body with a motor shaft arranged inside,

FIGS. 5A and 5B show different perspective views of an example food dispenser comprising a first example canister and a second example canister,

FIG. 6 is a schematic illustration of an example dispensing system comprising two food dispensers,

FIG. 7 is a flow chart illustrating an example method,

FIG. 8 schematically illustrates an example control unit,

FIG. 9 show another perspective views of an example first rotor in an example first canister,

FIG. 10 show another perspective view of an example first rotor,

FIG. 11 show a further perspective view of an example first rotor, and

FIG. 12 shows another example motor body with a motor shaft arranged inside.

### DETAILED DESCRIPTION

The present disclosure is described more fully below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

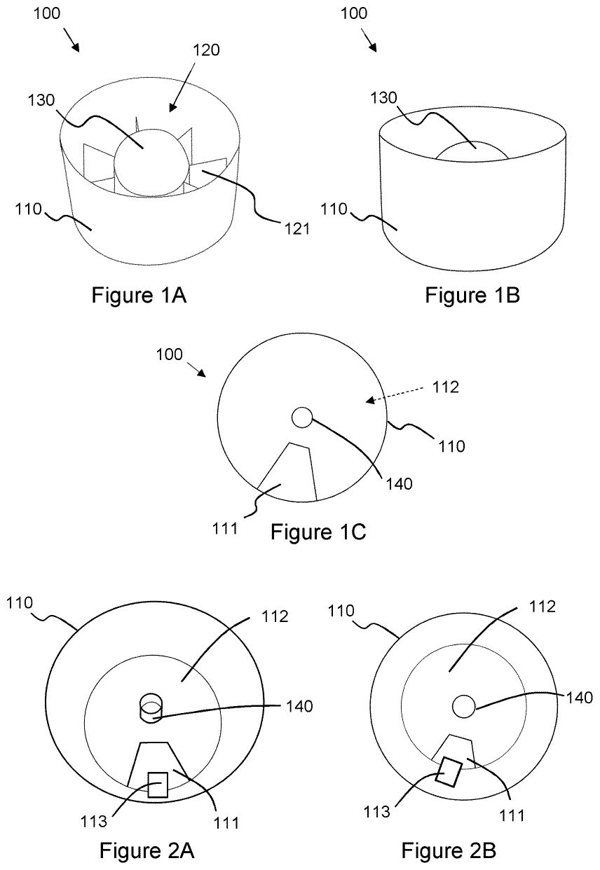

As mentioned, there is a need for improved food dispensers. FIG. 1A-1C show different views of an example food dispenser 100 disclosed herein. In particular, FIGS. 1A and 1B show different perspective views and FIG. 1C shows a bottom view.

The disclosed food dispenser 100 is suitable for distributing food onto a food tray. The food dispenser 100 comprises a first canister 110. The food may e.g. be pieces of food items such as pieces of salad or meatballs.

The first canister 110 is a container used for temporarily holding food. The first canister 110 is preferably cylindrical so as to provide close fit with a plurality of paddles of a first rotor, which is discussed in more detail below. Furthermore, the first canister 110 has an open face arranged to receive food. The first canister 110 may e.g. be dimensioned to fit in a commercial dishwasher. In an example, the first canister 110 is configured to contain a volume of 1-15 liters, which is a suitable size for ingredients such as salad. In another example, the first canister 110 is configured to contain a volume of 0.01-0.5 liters, which is a suitable size for ingredients such as herbs. Oher volumes are also possible.

The first canister 110 is provided with a bottom surface 112 onto which the received food is temporarily held. Food fed into the open face falls to the bottom surface 112 by gravity. If the first canister 110 is cylindrical, the bottom surface 112 may be in the form of a circular disc. Herein, “bottom” is relative to the open face of the first canister 110. In the example of FIGS. 1A-1C, the bottom surface 112 has a circular shape with a flat central portion. The flat central portion transitions to a sidewall of first canister via an arcuate portion. In this example, the flat central portion, the sidewall, and the arcuate portion are one integral part.

The first canister 110 may comprise any material suitable for temporarily being in contact with food. The material is preferably also easy to clean. Example materials are plastic or metals. A preferred material is stainless steel.

FIGS. 1A-1B show the first canister 110 from a view showing the open face, which may be referred to as a top view, and FIG. 1C show the first canister 110 from a view showing a surface opposite to the bottom surface 112 of the first canister 110, which may be referred to as a bottom view.

FIGS. 2A and 2B show different perspective views of an example first canister 110. FIG. 2A shows an angled view of the first canister 110 showing the open face, and FIG. 2B shows view straight into the open face.

The bottom surface 112 of the first canister is provided with an opening 111. The opening 111 is a hole in the bottom surface 112 through which food may be dispensed. In other words, the opening 111 is a through hole in the first canister 110. The opening 111 may have different shapes. In the example of FIGS. 1 and 2, the opening 111 extends from a distance from the center of the bottom surface 112 towards the sidewall of the first canister 110.

The bottom surface 112 of the first canister 110 may be conical and protruding inwards in the first canister 110. In particular, the bottom surface 112 may be conical with the top extending towards the open face of the first canister 110. This way, a larger amount of food received on the bottom surface 112 will be gathered away from the center of the bottom surface 112. This may be advantageous if a central part of a first rotor (discussed below) covers a part of the center of the bottom surface 112.

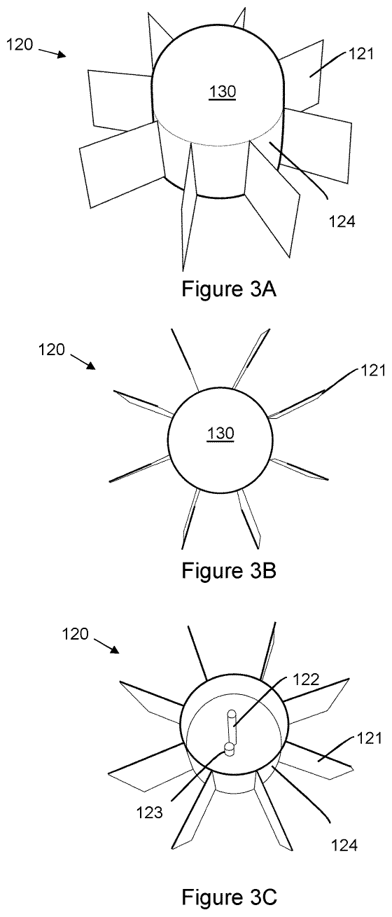

As is shown in FIG. 1A, the food dispenser 100 also comprises a first rotor 120 arranged adjacent to the bottom surface 112. The first rotor 120 is provided with a plurality of paddles 121. FIGS. 3A and 3C show different perspective views of an example first rotor 120. The first rotor 120 can also be called an impeller. The first rotor 120 being arranged adjacent to the bottom surface 112 means that the first rotor 120 is arranged such that the first rotor 120 may sweep food received on the bottom surface 112 of the first canister 110. As is shown in FIGS. 1 and 3A-3C, the paddles of the plurality of paddles 121 of the first rotor 120 may be flat and thin rectangular sections extending from a center part 124 of the first rotor 120. The paddles may have other shapes as well. Preferably, the paddles have a shape fitted to the bottom surface 112 of the first canister 110 and a section of the sidewall of the first canister 110 such that the there is little space between the parts of paddle facing the bottom surface 112 of the first canister 110 the section of the sidewall. Here, “little space” may be less than 2 mm. In the examples of FIGS. 1A, 3A-3C, the center part 124 is in the form of a cylinder. Other shapes are also possible, such as hexagonal. In FIGS. 1A, 3A-3C, the plurality of paddles 121 comprises eight paddles. Any number of paddles, however, are possible.

The plurality of paddles 121 of the first rotor 120 and the bottom surface 112 of the first canister 110 form a plurality of pockets in the first canister 110. A pocket is a sub-container within the first canister 110. The pockets are also arranged to receive and temporarily hold food. A pocket is formed by two adjacent paddles in the plurality of paddles 121 of the first rotor 120, a section of the bottom surface 112 of the first canister, a section of the sidewall of the first canister 110, and possibly also the center part 124 of the first rotor 120.

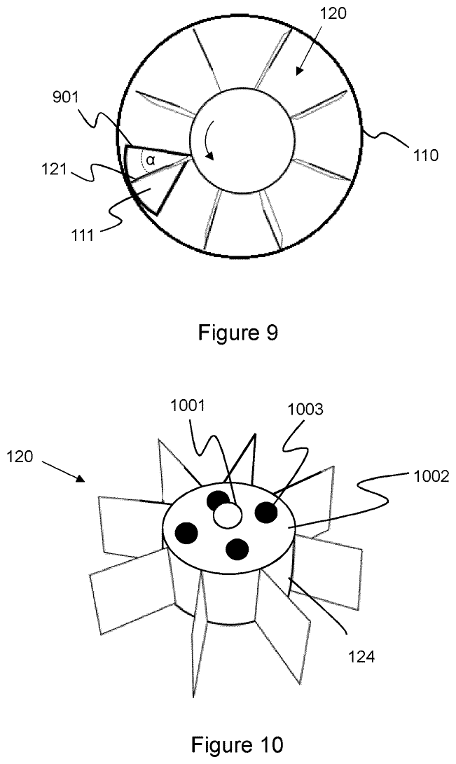

The opening 111 of the first canister 110 is positioned such that at least one pocket will be positioned at least partially overlapping with the opening 111 of the first canister 110 as the first rotor 120 rotates. Consequently, food held in the pockets will be dispensed from the opening 111 of the first canister 110 as the first rotor 120 rotates. The opening 111 of the first canister 110 may be dimensioned to match the size of a bottom part of a pocket (i.e., a surface of the pocket onto which food is held). Additionally, it should also be noted that the opening 111 of the first canister 110 may be formed such that there is an angular offset, a, between a first edge 901 of the opening 111 and the plurality of paddles 121 of the first rotor 120. This is shown in more detail in FIG. 9. This allows for the plurality of paddles 121 of the first rotor 120 to gradually meet the first edge of the opening 110 and thus for food received in the plurality of pockets in the first canister 110 to be gradually dispensed through the opening 111 of the first canister 110. This advantageously increases the accuracy of the dispensing of the food through the opening 110 since fewer pieces of food at a time may be dispensed. It advantageously also allows for a quicker dispensing of the food through the opening 110 in case the opening 110 is shaped such that food in a second pocket being dispensed by a second paddle is started just as the first paddle has finished dispensing the food from a first pocket.

The food dispenser 100 also comprises a first motor (not shown) configured to rotate the first rotor 120 to cause the plurality of paddles 121 of the first rotor 120 to sweep food received in the plurality of pockets in the first canister 110 through the opening 111 of the first canister 110. The first motor may e.g. be an electrical motor. The position of the first motor is discussed in more detail below.

The food dispenser 100 also comprises a first distribution head 130 arranged on the first rotor 120. The first distribution head 130 is configured to deflect food fed into the first canister 110 into the plurality of pockets in the first canister 110. The first distribution head 130 allows food fed into the first canister 110 to be evenly distributed into the plurality of pockets in the first canister 110 over time. The first distribution head 130 is preferably symmetrical with respect to a rotation axis of the first rotor 120. In the examples of FIGS. 1A and 3A, the first distribution head 130 has a semi-spherical shape. Other shapes are also possible, such as conical, pyramidal, or other convex shapes. The first distribution head 130 preferably matches the size of the central part 124 of the first rotor 120, or extend beyond the central part towards the sidewall of the first canister 110. Additionally, it should also be noted that the size of the first distribution head 130, and in some case also the size of the central part 124 of the first rotor 120, may preferably relate to the size of the first canister 110. For example, the size of first distribution head 130 and/or the central part 124 of the first rotor 120 may correspond to between a half (½) and a fourth (¼) of the radius of the first canister 110. This allows for a suitable distribution of the food fed into the canister 110 in relation to the plurality of pockets in the first canister 110, i.e. the first distribution head 130 and/or the central part 124 of the first rotor 120 not being too small or too large. However, it should be noted that other sizes of first distribution head 130 and/or the central part 124 of the first rotor 120 may also be implemented in dependence of the function of the canister 110 and/or food to be dispensed.

The first distribution head 130 and the first rotor 120 and its components, such as the plurality of paddles 121 of the first rotor 120 and the center part 124 of the first rotor 120, may comprise any material suitable for temporarily being in contact with food. The material is preferably also easy to clean. Example materials are plastic or metals. A preferred material is stainless steel.

The disclosed food dispenser 100 is an apparatus that is configured to automatically dispense food onto a food tray. A flow of food may be fed into the first canister 110. This flow of food may e.g. be fed into the first canister 110 manually or by means of a conveyor or such. The food being fed into the first canister 110 is likely to evenly distribute into the plurality of pockets in the first canister 110 over time. The flow of food fed into the first canister 110 may be continuous or discrete. The first motor is configured to rotate the first rotor 120 to cause the plurality of paddles 121 of the first rotor 120 to sweep food received in the plurality of pockets in the first canister 110 through the opening 111 of the first canister 110.

The disclosed food dispenser 100 thus enables dispensing food onto the food tray from the opening 111 in a controlled fashion. The food dispensed from the opening 111 will may be dispensed evenly over a time, where the dispense rate is controlled by the rotation speed of the first rotor 120. By controlling the rotation speed of the first rotor 120, the dispense rate of the food from the opening 111 can be controlled to a higher degree compared to the rate of food being fed into the first canister. As an example, a relatively large batch of food may be fed into the first canister 110 at one occasion. In that case, the food dispenser 100 enables a flow of smaller amounts of food to be distributed onto the food tray in a controlled fashion.

The first motor may be configured to control the rotation speed of the first rotor 120 based on measurements of a weight of the food that has been dispensed onto the food tray. In other words, the first motor may be configured to receive a signal indicating a weight of food on the food tray, where the first motor is configured to rotate the first rotor 120 as a function of the weight. The first motor may additionally be configured to receive another signal indicating the rate food is being fed into the first canister 110. This way, the first motor may be configured to rotate the first rotor 120 as a function of the weight and on the rate food is being fed into the first canister 110. The first motor may be configured to rotate the first rotor 120 slower as the amount of food received on the food tray approaches a target weight. Furthermore, the first motor may be configured to stop rotating the first rotor 120 when the food received on the food tray has reached the target weight.

As is shown in FIGS. 2A and 2B, the first canister 110 may comprise a shaft pipe 140 arranged in the first canister 110. The shaft pipe 140 is arranged extending from the bottom surface 112 of the first canister 110. In particular, the shaft pipe 140 of the first canister 110 extends towards the open face of the first canister 110 and in the rotational axis of the first rotor 120. The shaft pipe 140 of the first canister 110 is arranged to provide an opening from an inside of the first canister 110 to an outside of the first canister 110.

The first rotor 120 may further comprise a rotor shaft 122 configured to be driven by the first motor. The rotor shaft 122 of the first rotor 120 is further arranged extending through the shaft pipe 140 of the first canister 110. The shaft pipe 140 enables a mechanical connection between the first rotor 120 and the motor. The shaft pipe 140 of the first canister 110 also prevents food received in the first canister 110 from leaving the first canister 110 through other paths than the opening 111 of the first canister. In addition, the shaft pipe 140 enables the first rotor 120 to be snugly attached to the first canister 110 while being able to rotate freely within the first canister 110, which in turn enables a snug fit between the paddles and the bottom surface 112 of the first canister 110 and the sidewall of the first canister 110. The shaft pipe 140 may e.g. extend a few centimeters (such as 3-10 cm) from the bottom surface 112 of the first canister 110. In an example, the shaft pipe 140 extends from bottom surface 112 of the first canister 110 to the opening of the first canister 110. In general, it is desired to have the shaft pipe 140 extend as far as possible towards the opening as allowed by the particular shape of rotor (i.e., such that the paddles fit snugly with respect to the bottom and sidewalls of the first canister). Here, there is also an advantage to have the shaft pipe 140 extend at least beyond the top of the motor body 403 where the motor shaft 401 is anchored, since this will provides additional prevention against food contamination. Here, it should be particularly noted that for automatic food dispensers, there is also a risk of condensation food contamination. This means that vapor from hot food may attach to the automatic food dispenser and fall back to the food in the form of droplets. When the equipment meets a required cleanliness criteria, such droplets are less problematic. However, if the automatic food dispenser is based on an industrial robot arm that is not clean enough, the droplets may be very problematic. Therefore, handling hot food raises the food grade requirements in regards to condensation food contamination. Thus, most robot arms used in industrial applications are not suitable for automatic food dispensers. Equipment that meets the cleanliness criteria regarding condensation food contamination enables dispensing hot food, which opens up the possibility of deploying the equipment in a restaurant kitchen for instance. In the examples shown herein, condensation food contamination or droplet contamination is effectively avoided through the inherent placement of the first motor and its transmission.

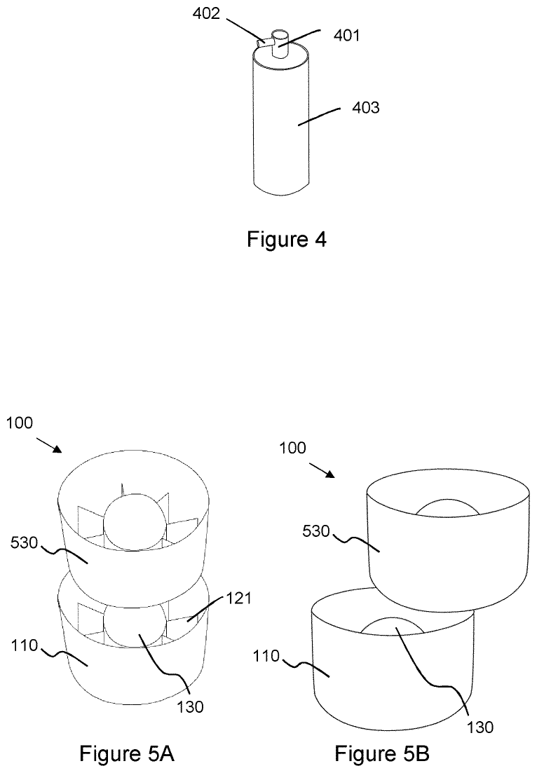

FIG. 4 shows an example motor body 403, which may be comprised in the food dispenser 100, with an example motor shaft 401 arranged inside. Note that the motor shaft 401 in the figure may be hollow. The motor body 403 is arranged to be received in the shaft pipe 140 of the first canister 110. In turn, the rotor shaft 122 of the first rotor 120 is arranged to be received inside the motor shaft 401. Preferably, the rotor shaft 122 is snugly received inside the motor shaft 401. The motor body 403 is arranged rotationally locked with respected to the first canister 110, whereas the motor shaft 401 can rotate freely with respect to the first canister 110. The motor body 403 is preferably releasably attached to the first canister 110.

The first rotor 120 is arranged to be rotationally locked with the motor shaft such that the first rotor 120 can rotate freely with respect to the first canister 110. FIGS. 3C and 4 show an example arrangement for rotationally lock the motor shaft 401 to the first rotor 120. In this example, the motor shaft 401 comprises a motor shaft arm 402 protruding from the motor shaft 401. This motor shaft arm 402 is arranged to push a pin 123 arranged on the first rotor 120, as is shown in FIG. 3C, when the rotor shaft 122 is received in the motor shaft 401 and when the first motor rotates the motor shaft 401. Other ways of rotationally lock the first rotor 120 to the motor shaft 401 are also possible. The first motor (not shown) may be arranged inside the motor body 403. Alternatively, the first motor may be connected to the motor shaft 401 via a transmission. In that case, the first motor may be attached anywhere on an outside of the first canister 110. Additionally, it should be noted that by arranging the first motor and the motor body 403 to operate from below the first canister 110 and inside the first rotor 120, respectively, as described above, the risk of contaminating the food with any motor parts, oils or other loose components is minimized, if not eliminated completely.

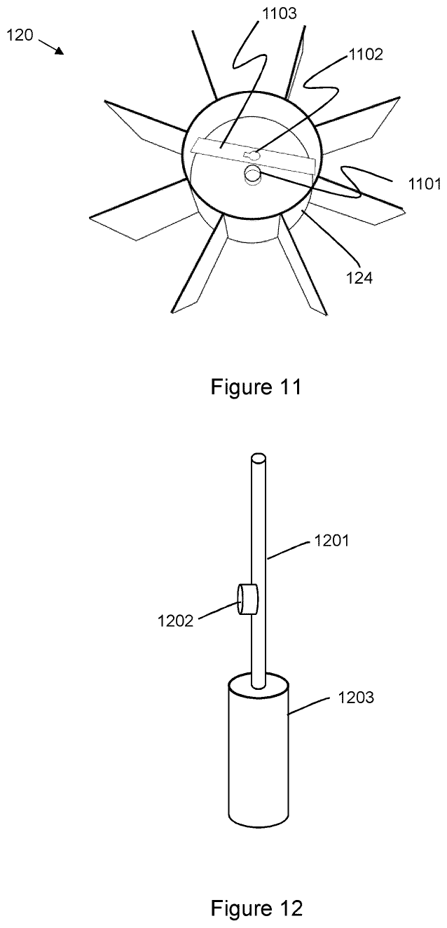

Further examples and optionally configurations of the first rotor 120 and the motor body 403 is shown in FIGS. 11-12. Here, the first rotor 120 may comprise a rotator cuff 1101 instead of a rotor shaft 122. The rotator cuff 1101 may be arranged to receive a motor shaft 1201 of a motor body 1203. Note that the motor shaft 1201 in the figure may be solid. The motor body 1203 is arranged to be received in the shaft pipe 140 of the first canister 110. In turn, the motor shaft 1201 of the motor body 1203 is arranged to be inserted through an opening 1102 in a crossbar 1103 diagonally fitted inside the rotor 120 and subsequently received snugly inside the rotator cuff 1101. The motor body 1203 is arranged rotationally locked with respected to the first canister 110, whereas the motor shaft 1201 can rotate freely with respect to the first canister 110. The motor body 1203 is preferably releasably attached to the first canister 110.

The first rotor 120 is arranged to be rotationally locked with the motor shaft 1201 such that the first rotor 120 can rotate freely with respect to the first canister 110. FIGS. 11-12 show an example arrangement for rotationally lock the motor shaft 1203 to the first rotor 120. In this example, the motor shaft 1201 comprises a motor shaft arm 1202 protruding from the motor shaft 1201. This motor shaft arm 1202 is arranged to fit in the opening 1102 in the crossbar 1103 and be mechanically form-locked within the opening 1102. This allows the motor shaft arm 1201 to rotate the first rotor 120 around its central axis when the first motor rotates the motor shaft 1201. Other ways or mechanical connections of rotationally lock the first rotor 120 to the motor shaft 1201 are also possible. The first motor (not shown) may be arranged inside the motor body 1201. Alternatively, the first motor may be connected to the motor shaft 1201 via a transmission. In that case, the first motor may be attached anywhere on an outside of the first canister 110.

The food dispenser 100 is preferably arranged such that it is disassemblable and easy to clean. This may be achieved by having the first rotor 120 releasably attached to the first canister 110. Preferably, the first rotor 120 is releasably attached to the first canister 110 such that the first rotor 120 and the first canister 110 can be disassembled and reassembled without using tools.

In the example of FIGS. 1-4, the first rotor 120 comprises the center part, the plurality of paddles 121, the rotor shaft 122, and the pin 123 attached to each other to form a single piece. These components may e.g. be attached to each other by welding. Furthermore, the shaft pipe 140 is attached to the first canister 110 to form a single piece, e.g. by means of welding the shaft pipe 140 to the first canister 110. The motor body 403 is releasably attached to the first canister 110 such that the motor shaft 401 can rotate freely. The first rotor 120 is releasably attached to the first canister 110 by means of having the first rotor 120 bear on the motor shaft 401.

Furthermore, the first distribution head 130 may be releasably attached to the first rotor 120. Preferably, the first distribution head 130 is releasably attached to the first rotor 120 such that the first distribution head 130 and the first rotor 120 can be disassembled and reassembled without using tools. This way, it is easier to clean the first distribution head 130 and the first rotor 120. For example, the first distribution head 130 may be arranged bearing on the first rotor 120. Alternatively, the first distribution head 130 may be attached to the first rotor 120 via a snap-fit attachment arrangement. Additionally, it should here be noted that the inside of the center part 124 of the first rotor 120 revealed once the first distribution head 130 is disassembled from the first rotor 120, as shown in FIG. 3C, may, for example, be completely covered to prevent any unwanted materials/liquids to enter inside the center part 124 of the first rotor 120. Optionally, the center part 124 of the first rotor 120 may also be provided with a handle 1001 as shown in FIG. 10, e.g. across the diameter of the center part 124 of the first rotor 120 or affixed to the cover 1002 of the inside of the center part 124 of the first rotor 120. This advantageously enables an operator to easily, and in a more secure manner, lift the first rotor 120 out of the first canister 110. Optionally, the handle 1001 may be shaped as knob or similar shape in order to prevent any fingers from being inserted into the handle will lifting the first rotor 120 out of the first canister 110. Furthermore, although a complete cover of the inside of the center part 124 of the first rotor 120 may sometime be preferable, it should also be noted that having a handle or cover that only partly covers the inside of the center part 124 of the first rotor 120 may allow for an easier re-assembly of the first rotor 120, e.g. fitting the rotor shaft 122 of the first rotor 120 with the motor shaft 401, by providing a clear line of sight, e.g. the through holes 1003 in FIG. 10.

As is shown in the example of FIGS. 2A and 2B, the first canister 110 may comprise a blocking member 113 arranged adjacent to the opening 111 of the first canister 110 to prevent food fed into the first canister 110 from being directly fed through the opening 111 of the first canister 110. The blocking member 113 is a protrusion extending inwards from the sidewall of first canister 110. The blocking member 113 is attached to the first canister 110 such that it is rotationally locked with the first canister 110. In FIGS. 2A and 2B, the blocking member 113 has a flat rectangular shape extending form the sidewall of the first canister 110 into the center of the first canister 110. Other shapes are also possible, such as an arcuate shape or a cylindrical shape. The blocking member 113 may extend in a direction perpendicular to the rotation axis of the first rotor 120, or at an angle relative to the rotation axis of the first rotor 120. When looking straight into the open face of the first canister 110, the blocking member 113 may be arranged above the opening 111 of the first canister 110. When food is fed into the first canister, any food falling towards the opening 111 is at least partially blocked by the blocking member 113. This way, the flow rate of food dispensed from the opening 111 of the first canister 110 is more controlled.

FIGS. 5A and 5B show different perspective views of an example food dispenser 100 comprising the first canister 110 and a second canister 530. The second canister 530 may comprise all features of the first canister 110 discussed above. The second canister 530 is provided with a second rotor which may comprise all features of the first rotor 120 discussed above. In this example, the first and the second canisters 110, 530 have been cascaded such that food dispensed from an opening of the second canister 530 is fed into the first canister 110. Arranging two canisters like this provides more control of the food distributed by the food dispenser 100 relative to the food fed into the food dispenser 100.

In general, the food dispenser 100 may comprise a second canister 530 provided with an opening in a bottom surface of the second canister 530, and a second rotor arranged adjacent to the bottom surface of the second canister 530. The second rotor is provided with a plurality of paddles, wherein the plurality of paddles of the second rotor and the bottom surface of the second canister 530 form a plurality of pockets in the second canister 530. The second rotor is configured to be rotated such that the plurality of paddles of the second rotor sweep food received in the plurality of pockets in the second canister 530 through the opening of the second canister 530. The second canister 530 is arranged such that food fed from the opening of the second canister 530 is fed into the first canister 110.

The second rotor is preferably provided with a second distribution head, where the second distribution head may comprise all features of the first distribution head 130 as discussed above.

The food dispenser 100 may comprise additional cascaded canisters such that each canister, except the topmost canister, is feed food from another canister above, and such that the bottommost canister dispenses food onto the food tray.

The first and the second canisters 110, 530 may be arranged relative to each other by means of being attached to holding arrangement, such as a frame, which is discussed in more detail below. The food dispenser 100 may be arranged to such holding arrangement in a modular way, where any number of desired canisters can be cascaded depending on a desired control of the flow of food distributed from the food dispenser 100.

The first canister 110 may have a cylindrical shape extending along a first axis. In that case, the first and the second canisters 110, 530 may be arranged such that the first axis extends through the first distribution head 130 and the opening of the second canister 530. This is an effective way of arranging the first and the second canisters such that food fed from the opening of the second canister 530 is fed onto the first distribution head 130, which will evenly distributed the food in to the plurality of pockets in the first canister 110 over time.

Alternatively, the first and the second canisters are arranged coaxially, i.e., the second canister 530 is placed directly over the first canister 110. In that case, a guiding arrangement, such as a pipe, may direct food from the hole of the second canister towards the first distribution head 130. An advantage of this arrangement is that the whole arrangement takes up less space in the horizontal direction. However, more space may be required in the vertical direction, and the guiding arrangement is preferably included.

The second rotor may be configured to be rotated by the by the first motor. Furthermore, the first motor may be configured to rotate the first rotor 120 at a first peripheral speed and to rotate the second rotor at a second peripheral speed, wherein the second peripheral speed is slower than the first peripheral speed. Peripheral speed is the speed on the periphery or the circumference of the rotor. The first motor may be mechanically connected to the first and the second rotors by different transmissions. According to some additional aspects, the second peripheral speed may be slower than the first peripheral speed on average over a predetermined amount of time. According to some other aspects, the first motor may be configured to rotate the first rotor 120 at a first rotational speed and to rotate the second rotor at a second rotational speed, wherein the second rotational speed is slower than the first rotational speed.

Alternatively, the food dispenser 100 may further comprise a second motor configured to rotate the second rotor. In that case, the first motor may be configured to rotate the first rotor 120 at a first peripheral speed and the second motor may be configured to rotate the second rotor at a second peripheral speed, wherein the second peripheral speed is slower than the first peripheral speed. Here, the second peripheral speed may be slower than the first peripheral speed on average over the predetermined amount of time. According to some other aspects, the first motor may be configured to rotate the first rotor 120 at a first rotational speed and the second motor may be configured to rotate the second rotor at a second rotational speed, wherein the second rotational speed is slower than the first rotational speed.

The different speeds (rotational or peripheral) of the first rotor and the second rotor (in absolute terms or on average over the predetermined amount of time) allows the food to be distributed with more control through the food dispenser 100. In other words, the food may be distributed with a higher granularity. Using two rotors with different speeds increases the control of the distribution but at the cost of distribution time. As an example, food fed into the second canister 530 is distributed into the first canister 110 in controlled fashion by means of the second rotor, i.e., the flow rate is controlled. Thereafter, food distributed from the first canister 110 is controlled to a higher degree.

As an example, the first rotor may be rotated by 5 revolutions per minute (rpm) and the second rotor is rotated by 1 rpm. The rotor may e.g. be rotated between 5 to 10 times faster than the second rotor in terms of peripheral speed or rotational speed. Other values of the difference in speed are also possible.

In another example, the first rotor is rotated in pulses, namely periodically being rotated at 2 rpm for 5 seconds followed by a 5 second period with no rotation. In this example, the second rotor is also rotated in pulses, namely periodically being rotated at 2 rpm for 5 seconds followed by a 10 second period with no rotation. Here, the predetermined amount of time may e.g. be 1 minute.

In an example, the first and the second canisters 110, 530 comprise ten pockets each. Initially, the first and the second canisters 100, 530 are empty regarding food. At a first step, food is added and evenly spread out within the ten pockets of the second canister 530. The second rotor is thereafter rotated such that food of one entire pocket of the second canister 530 is fed onto the distribution head of the first canister 110. It is assumed that the content from that pocket in the second canister 530 is evenly spread out into the ten pockets in the first canister 110. When it is desired to dispense food from the food dispenser 100, the first rotor 120 is rotated and the content of the pockets of the first canister 110 is swept through the opening 111 of the first canister 110. The first rotor 120 is rotated until a target amount to dispense has been reached or until all the pockets of the first canister 110 are empty. If all the pockets in the first canister 110 are empty, which happens when the first rotor 120 has turned one entire revolution, content from another pocket of the second canister 530 is swept onto the distribution head of the first rotor to be able to continue dispensing food from the food dispenser 100. Sweeping pocket-by-pocket using ten pockets in both the first canister 110 and the second canister 530 implies dividing the initially added amount into the second canister 530 one hundred times. Since the food is spread out by the distribution heads by chance, the division of a hundred times is in practice likely not an exact division (e.g. due to a non-perfect distribution by the first distribution head). However, in practice, most dispensed portions are within an accepted interval. It should also be noted that the content of food in one pocket in the first canister is typically not dispensed all at once. Rather, the dispensing of the content of food in a pocket is dispensed gradually through the opening as the first rotor rotates. In this example of the previous paragraph, the first rotor is rotating faster than the second rotor. The provided control of the distribution of food according to this example would also be achieved if both the first and the second rotors had constant (different) speeds or speeds with another pattern, as long as the second rotor rotates slower than the first rotor at least on average over time.

As mentioned, any number of paddles are possible on the first and the second rotors. The control of food dispensed through a canister increases with number of paddles. Thus, for a given type of food, it may be advantageous to provide a rotor (first and/or second) with as many paddles as possible without the food clogging between the paddles that would disable the food falling down through the opening of the canister. The control of food dispensed through a canister is also increased with a larger size of the rotor since that provides more room for more paddles. Furthermore, a bigger center part of the rotor increases the control since the pocket size is decreased. Furthermore, when the length of the paddles is a smaller fraction of the radius of the canister, the minimal distance between two adjacent paddles increases, which reduces the risk of food clogging between the paddles. A slower speed (rotational or peripheral) of the rotor also increases the control, however, at a cost of decreased speed of the dispensing. Increased control can also be obtained by cascading more canisters in addition to the first and the second canisters. Another way of increasing the control is to introduce smaller batches of food into the second canister. Among these ways of increasing the control of the food dispensed by the food dispenser, there is typically a trade-off between a total physical volume, speed of dispensing the food, and the amount of control.

If the food dispenser 100 with the first and the second canisters 110, 530 only comprises the first motor, the first motor is arranged to drive the first and the second rotors via respective transmissions. If, on the other hand, said food dispenser 100 comprises the first and the second motors, the first motor may e.g. be attached to an outside of the first canister 110 and be configured to rotate the first rotor 120, and the second motor may e.g. be attached to an outside of the second canister 530 and be configured to rotate the second rotor. The second motor may comprise the same features as the first motor discussed above. In addition, the second motor may mechanically connected to the second rotor in the same ways as the first motor may be mechanically connected to the first rotor 120.

When the food dispenser 100 with the first and the second canisters 110, 530 comprises the first and the second motors, each of the first and the second motors may be configured to receive a signal indicating a weight of food on the food tray, where the first motor is configured to rotate the first rotor 120 as a function of the weight and the second motor is configured to rotate the second rotor as a function of the weight. Each of the first and the second motors may additionally be configured to receive another signal indicating the rate food is being fed into the second canister 530.

When the food dispenser 100 with the first and the second canisters 110, 530 comprises only the first motor, the first motor may be configured rotate the first and the second rotors with different speeds by means of different gears.

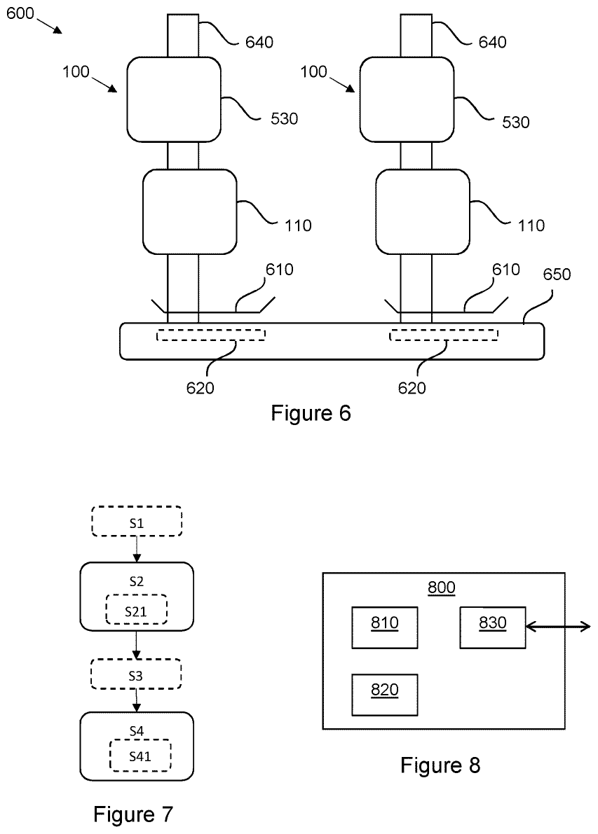

There is also disclosed herein a food dispensing system 600 comprising two or more food dispensers 100 according to the discussions above and a conveyor system 650. The conveyor system 650 is arranged to convey the food tray 610 between different food dispensers of the two or more food dispensers 100. FIG. 6 shows a schematic illustration of an example dispensing system 600 comprising two food dispensers 100.

The food dispensing system 600 can advantageously fill the food tray with different ingredients in an automatic fashion. Each food dispenser 100 in the food dispensing system 600 may be associated with a respective scale 620 comprised in the food dispensing system. Each scale 620 is adapted to weigh food dispensed on the food tray when the food tray is positioned to receive food dispensed from the associated food dispenser. Each scale 620 may be configured to communicate a signal indicating the weight from that scale 620 to the first motor of the associated food dispenser 100, and to the second motor if the associated food dispenser 100 comprises a second motor. Consequently, the first motor may be configured to rotate the first rotor 120 in response to the signal from the associated scale 620. Similarly, the second motor may be configured to rotate the second rotor in response to the signal from the associated scale 620. Here, it should also be noted that in some cases the scale 620 may be replaced with a camera and computational hardware (not shown) configurable to run a software or program code, wherein the software or program code may be configured to determine the weight of the food on the food tray 610 and cause the computational hardware to output a signal indicating the weight of the food on the food tray 610, e.g. similar to that of the scale 620.

The example of FIG. 6 comprises two food dispensers 100, where each of the two food dispensers 100 comprises the first and the second canisters 110, 530, the first and the second canisters 110, 530 are attached to a holding arrangement 640 for each of the two food dispensers 100. The holding arrangement 640 may e.g. comprise respective pillar for each food dispenser 100 comprised in the food dispensing system 600.

When the food dispensing system comprises two or more food dispensers 100, each of the two or more food dispensers 100 may be configured to distribute respective ingredients of food.

In FIG. 6, the conveyor system 650 is configured to first position the food tray 610 to receive a first ingredient dispensed from leftmost food dispenser 100. In that position, the leftmost food dispenser 100 dispenses a first ingredient into the food tray 610 based on a signal from the scale 620 at that position. When a weight of the first ingredient distributed into the food tray 610 reaches a target weight, the leftmost food dispenser 100 stops distributing the first ingredient into the food tray 610 by means of the first and the second rotors stopping to rotate. Thereafter, the conveyor system 650 is configured to position the food tray 610 to receive a second ingredient dispensed from rightmost food dispenser 100. In that position, the rightmost food dispenser 100 dispenses the second ingredient into the food tray 610 based on a signal from the scale 620 at that position. When a weight of the second ingredient distributed into the food tray 610 reaches a target weight, the rightmost food dispenser 100 stops distributing the second ingredient into the food tray by means of the first and the second rotors stopping to rotate.

FIG. 7 is flow chart illustrating a method for distributing food using the food dispenser 100 according to the discussions above. The method comprises a number of steps, which are listed below.
Step 1 (S1). Optionally, the method comprises receiving a food quantity into the second canister 530, if the method uses the food dispenser 100 comprising the second canister 530.
Step 2 (S2). The method comprises receiving a food quantity into the first canister 110.

If the method uses the food dispenser 100 comprising the second canister 530, the receiving a food quantity into the first canister 110 comprises expelling (S21) food distributed in the plurality of pockets in the second canister 530 from the opening of the second canister 530 by rotating the second rotor.
Step 3 (S3). The method may further comprise obtaining a weight of food distributed on the food tray 610.
Step 4 (S4). The method comprises expelling food distributed in the plurality of pockets in the first canister 110 from the opening 111 of the first canister 110 by rotating the first rotor 120 by the first motor.

If the weight is obtained at Step 3, the method further comprises rotating (S41) the first rotor 120 by the first motor as a function of the obtained weight.

In the disclosed method, the first rotor 120 may be rotated at the first peripheral speed and the second rotor may be rotated at the second peripheral speed.

FIG. 8 schematically illustrates, in terms of a number of functional units, the components of a control unit 800 according to embodiments of the discussions herein. This control unit 800 may be comprised in the food distribution 600 discussed above. Processing circuitry 810 is provided using any combination of one or more of a suitable central processing unit CPU, multiprocessor, microcontroller, digital signal processor DSP, etc., capable of executing software instructions stored in a computer program product, e.g. in the form of a storage medium 830. The processing circuitry 810 may further be provided as at least one application specific integrated circuit (ASIC), or field programmable gate array (FPGA).

Particularly, the processing circuitry 810 is configured to cause the control unit 800 to perform a set of operations, or steps, such as the methods discussed in connection to FIG. 7. For example, the storage medium 830 may store the set of operations, and the processing circuitry 810 may be configured to retrieve the set of operations from the storage medium 830 to cause the control unit 800 to perform the set of operations. The set of operations may be provided as a set of executable instructions. Thus, the processing circuitry 810 is thereby arranged to execute methods as herein disclosed.

In particular, the control unit may e.g. initiate receiving S1 a food quantity into the first canister 110 by means of a conveyor, or by indicating, e.g., by means of blinking a light, that the food quantity should be fed into the first canister 110 manually.

The storage medium 830 may also comprise persistent storage, which, for example, can be any single one or combination of magnetic memory, optical memory, solid-state memory or even remotely mounted memory.

The control unit 800 may further comprise an interface 820 for communications with at least one external device. As such, the interface 820 may comprise one or more transmitters and receivers, comprising analogue and digital components and a suitable number of ports for wireline or wireless communication.

The processing circuitry 810 controls the general operation of the control unit 800, e.g., by sending data and control signals to the interface 820 and the storage medium 830, by receiving data and reports from the interface 820, and by retrieving data and instructions from the storage medium 830. Other components, as well as the related functionality, of the control unit are omitted in order not to obscure the concepts presented herein.

There is also disclosed herein a computer readable medium carrying a computer program comprising program code means for performing the methods illustrated in FIG. 7, when said program product is run on a control unit. The computer readable medium and the code means may together form a computer program product.

### REFERENCE SIGNS

100: Food dispenser
110: First canister
111: Opening
112: Bottom surface
113: Blocking member
120: First rotor
121: Plurality of paddles
122: Rotor shaft
123: Pin
124: Center part
130: First distribution head
140: Shaft pipe
401, 1201: Motor shaft
402,1202: Motor shaft arm
403, 1203: Motor body
530: Second canister
600: Food dispensing system
610: Food tray
620: Scale
640: Holding arrangement
650: Conveyor system
800: Control unit
810: Processing circuitry
820: Interface
830: Storage medium
1001: Handle
1002: Cover
1101: Rotator cuff
1103: Crossbar

1. A food dispenser for distributing food onto a food tray, comprising
a first canister provided with an opening in a bottom surface of the first canister,
a first rotor arranged adjacent to the bottom surface of the first canister, the first rotor being provided with a plurality of paddles, wherein the plurality of paddles of the first rotor and the bottom surface of the first canister form a plurality of pockets in the first canister,
a first motor configured to rotate the first rotor to cause the plurality of paddles of the first rotor to sweep food received in the plurality of pockets in the first canister through the opening of the first canister, and
a first distribution head arranged on the first rotor, the first distribution head being configured to deflect food fed into the first canister into the plurality of pockets in the first canister.
a second canister provided with an opening in a bottom surface of the second canister, and
a second rotor arranged adjacent to the bottom surface of the second canister, the second rotor being provided with a plurality of paddles, wherein the plurality of paddles of the second rotor and the bottom surface of the second canister form a plurality of pockets in the second canister,
wherein the second rotor is configured to be rotated such that the plurality of paddles of the second rotor sweep food received in the plurality of pockets in the second canister through the opening of the second canister,
wherein the second canister is arranged such that food fed from the opening of the second canister is fed into the first canister.

2. The food dispenser according to claim 1, wherein the first motor is configured to receive a signal indicating a weight of food on the food tray, wherein the first motor is configured to rotate the first rotor as a function of the weight.

3. The food dispenser according to claim 1, wherein the first canister comprises a shaft pipe arranged in the first canister and arranged extending from the bottom surface of the first canister, the shaft pipe providing an opening from an inside of the first canister to an outside of the first canister, and wherein the first rotor comprises a rotor shaft configured to be driven by the first motor, wherein the rotor shaft of the first rotor is arranged extending through the shaft pipe of the first canister.

4. The food dispenser according to claim 1, wherein the first canister comprises a shaft pipe arranged in the first canister and arranged extending from the bottom surface of the first canister, the shaft pipe providing an opening from an inside of the first canister to an outside of the first canister, and wherein the first rotor comprises a rotary cuff arranged to receive a motor shaft driven by the first motor, and a crossbar configured to be rotated by the motor shaft.

5. The food dispenser according to claim 1, wherein the first rotor is releasably attached to the first canister.

6. The food dispenser according to claim 1, wherein the first distribution head is releasably attached to the first rotor.

7. The food dispenser according to claim 1, wherein the first distribution head has a semi-spherical shape.

8. The food dispenser according to claim 1, wherein the first canister further comprises a blocking member arranged adjacent to the opening of the first canister to prevent food fed into the first canister from being directly fed through the opening of the first canister.

9. The food dispenser according to claim 1, wherein the bottom surface of the first canister is conical and is protruding inwards in the first canister.

10. The food dispenser according to claim 9, wherein the first canister has a cylindrical shape extending along a first axis, wherein the first and the second canisters are arranged such that the first axis extends through the first distribution head and the opening of the second canister.

11. The food dispenser according to claim 9, wherein the second rotor is configured to be rotated by the first motor.

12. The food dispenser according to claim 11, wherein the first motor is configured to rotate the first rotor at a first peripheral speed and to rotate the second rotor at a second peripheral speed, wherein the second peripheral speed is slower than the first peripheral speed.

13. The food dispenser according to claim 9, further comprising a second motor configured to rotate the second rotor.

14. The food dispenser according to claim 13, wherein the first motor is configured to rotate the first rotor at a first peripheral speed and the second motor is configured to rotate the second rotor at a second peripheral speed, wherein the second peripheral speed is slower than the first peripheral speed.

15. A food dispensing system comprising two or more food dispensers according to claim 1 and a conveyor system, wherein the conveyor system is arranged to convey the food tray between different food dispensers of the two or more food dispensers.

16. A method for distributing food using a food dispenser according to claim 1, the method comprising:
receiving a food quantity into the first canister; and
expelling food distributed in the plurality of pockets in the first canister from the opening of the first canister by rotating the first rotor by the first motor.

17. The method according to claim 16, further comprising
obtaining a weight of food distributed on the food tray, and
rotating the first rotor by the first motor as a function of the obtained weight.

18. The method according to claim 16 when using the food dispenser, wherein the bottom surface of the first canister is conical and is protruding inwards in the first canister, comprising
receiving a food quantity into the second canister, wherein the receiving a food quantity into the first canister comprises
expelling food distributed in the plurality of pockets in the second canister from the opening of the second canister by rotating the second rotor.

19. The method according to claim 18 when using the food dispenser according to claim 13, wherein the first rotor is rotated at the first peripheral speed and the second rotor is rotated at the second peripheral speed.
